(19) United States
(12) Patent Application Publication
(10) Pub. No.: US 2008/0154019 A1
(43) Pub. Date: Jun. 26, 2008

(54) Polythiophene derivatives

(75) Inventors: Gue-Wuu Hwang, Kaohsiung (TW); Yi-Ling Chen, Chiayi County (TW); Shin-Lei Lin, Kaohsiung City (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/806,181

(22) Filed: May 30, 2007

(30) Foreign Application Priority Data
Dec. 22, 2006 (TW) 95148463

(51) Int. Cl. C08G 75/00

(52) U.S. Cl. 528/380

(57) ABSTRACT

A polythiophene derivative having formula (I):

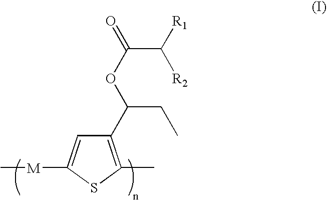

wherein M comprises

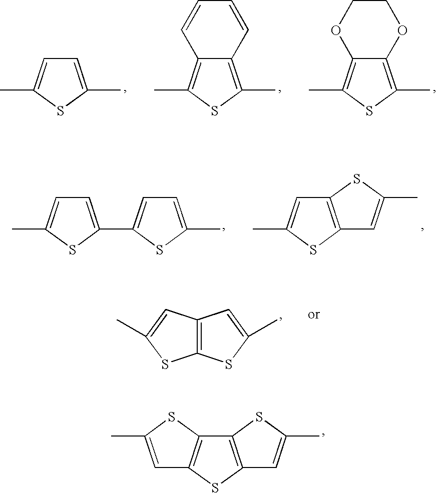

comprises C1˜C20 alkyl or C1˜C20 alkoxyalkyl, R₂ comprises hydrogen, C1˜C20 alkyl, or C1˜C20 alkoxyalkyl, and n is 1˜400. The polythiophene derivative with formula (I) is easily dissolved in common organic solvent due to the soluble ester side chain group thereof. The soluble polythiophene derivative with formula (I) can be widely applied in semiconductor fabrication such as solution-based deposition methods.

### BACKGROUND OF THE INVENTION

1. Field of the Invention

The invention relates to a conjugated heterocyclic polymer, and more particularly to a polythiophene derivative.

2. Description of the Related Art

Organic semiconductors had already been demonstrated in applications of electronic devices such as organic light-emitting diodes (OLEDs), organic thin-film transistors (OTFTs), and organic solar cells (OSCs). The unique processing characteristics and demonstrated performance of electronic devices suggest that organic semiconductors can be competitive candidates for flexible electronics applications requiring large area coverage, structural flexibility, low temperature processing, and especially low cost.

In order to construct organic semiconductors onto plastic substrates by using a simple low cost process. The solubility of organic semiconductors is a particularly important requirement for use in solution-based deposition methods such as spin-coating, ink-jet printing, or stamping. However, the highly conjugated semiconducting polymers provide poor solubility due to their rigid structure. To improve solubility, introduction of solubilizing group to the polymer chain is necessary. However, the non-conjugated side chain group reduced the packing density in the polymer. Therefore, development of a novel soluble polymer derivative containing a removable side chain group is desirable.

M. J. Frechet (J. Am. Chem. Soc. 2004, 126, 9486-9487) discloses a polythiophene containing an ester functional group. The ester functional group is converted into a carboxyl functional group by thermal treatment.

A. R. Murphy (J. Am. Chem. Soc. 2004, 126, 1596-1597) discloses a diester-substituted sexithiophene containing an ester group conducted to the terminal thereof. The ester group is converted into an alkene group by thermal treatment.

### BRIEF SUMMARY OF THE INVENTION

An embodiment of the invention provides a polythiophene derivative having formula (I):

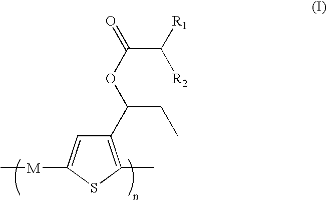

wherein M comprises

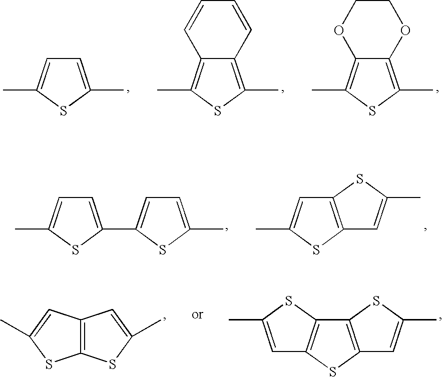

comprises C1˜C20 alkyl or C1˜C20 alkoxyalkyl, R₂ comprises hydrogen, C1˜C20 alkyl, or C1˜C20 alkoxyalkyl, and n is 1˜400.

An embodiment of the invention provides a polythiophene derivative having formula (II)

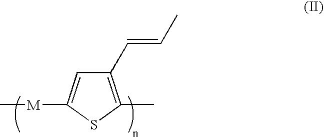

wherein M comprises

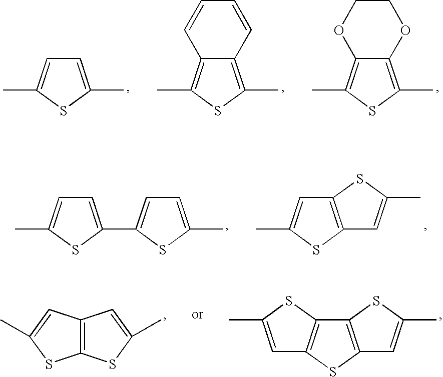

and n is 1˜400.

The polythiophene derivative with formula (I) is easily dissolved in common organic solvent due to the soluble ester side chain group thereof After removal of the ester group by heating, the conjugated polythiophene derivative with formula (II) containing the alkene side chain group is formed. The soluble polythiophene derivative with formula (I) can be widely applied in semiconductor fabrication such as solution-based deposition methods. The conjugated polythiophene derivative with formula (II) containing the alkene group can increase the packing density thereof.

A detailed description is given in the following embodiments

### DETAILED DESCRIPTION OF THE INVENTION

The following description is of the best-contemplated mode of carrying out of the invention. This description is made for the purpose of illustrating the general principles of the invention and should not be taken in a limiting sense. The scope of the invention is best determined by reference to the appended claims.

An embodiment of the invention provides a polythiophene derivative having formula (I):

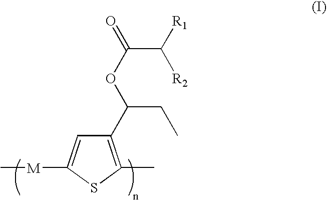

In formula (I), M may comprise

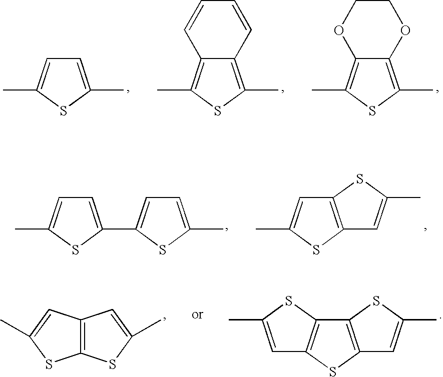

R₁ may comprise C1˜C20 alkyl or C1˜C20 alkoxyalkyl. R₂ may comprise hydrogen, C1˜C20 alkyl, or C1˜C20 alkoxyalkyl, and n may be 1˜400.

The polythiophene derivative is soluble in organic solvents due to conduction of an ester side chain group.

An embodiment of the invention provides a polythiophene derivative having formula (II):

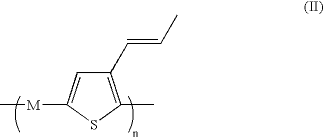

In formula (II), M may comprise

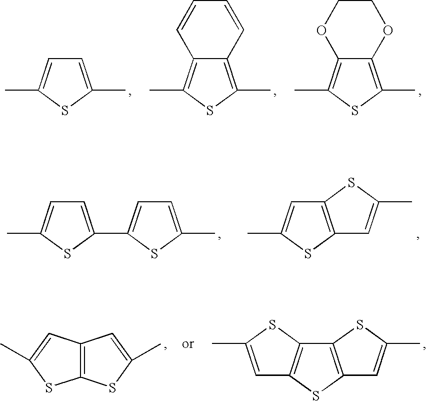

and n may be 1˜400.

The polythiophene derivative, a planar and conjugated polymer, is insoluble in organic solvent due to conduction of an alkene side chain group.

The polythiophene derivatives of formula (I) and (II) are polymeric semiconductor materials, widely applied in various organic semiconductor devices such as organic thin film transistors, organic solar cells, or organic light emitting diodes. The polythiophene derivatives may also be doped with oxidizers such as ferric chloride (FeCl₃) or iodine (I₂) or protonic acids to increase conductivity thereof so as to be utilized as conductor. Additionally, the polythiophene derivatives can be blended with various polymers such as polymethyl methacrylate (PMMA) to improve mechanical strength.

The polythiophene derivatives of formula (I) and (II) are prepared as described in the following. In a basic condition, a thiophene halide monomer such as 3-bromothiophene is reacted with an anhydride such as propionic anhydride. After reduction and esterification, a thiophene monomer containing an ester group is formed. After polymerization, the polythiophene derivative of formula (I) is prepared. After heating, the polythiophene derivative of formula (II) is prepared.

### EXAMPLE 1

### (Preparation of thiophen-3-yl-propan-1-one)

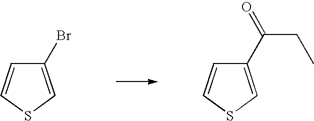

1.1 e.q. n-butyl lithium (n-BuLi) and −78° C. dry ether were mixed in a first flask under nitrogen. Next, 1 e.q. 3-bromothiophene was slowly added to the first flask and stirred for 10 min at −78° C. 1.25 e.q. magnesium bromide (MgBr₂) and dry ether were mixed in a second flask and stirred for 10 min. Next, the first and second flasks were slowly mixed and stirred for 30 min at −40° C. to form an intermediate. 2.3 e.q. propionic anhydride and dry ether were mixed in a third flask and stirred for 10 min at −78° C. Next, the −4° C. intermediate was slowly added to the third flask and stirred for 4 hours at −78° C. to prepare a reaction solution. After warming to −10° C., an ammonium chloride (NH₄Cl) aqueous solution was added to neutralize the reaction solution. The resulting solution was then extracted 3 times with water to remove salts. After removing the water with magnesium sulfate (MgSO₄), removing the ether, and vacuum distillation, thiophen-3-yl-propan-1-one was obtained.

### EXAMPLE 2

### (Preparation of 1-thiophen-3-yl-propan-1-ol)

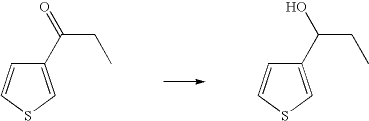

1 e.q. thiophen-3-yl-propan-1-one diluted by tetrahydrofuran (THF) was slowly added to a flask containing 2 e.q. lithium aluminum hydride (LAH) and tetrahydrofuran (THF) at 0° C. to form a solution. After warming to room temperature, the solution was stirred for 3 hours. Methanol was then added to terminate the reaction of the excess lithium aluminum hydride (LAH). Next, the solution was extracted with ethyl acetate and water. After removing water with magnesium sulfate (MgSO₄) and removing ethyl acetate, the results were purified to form 1-thiophen-3-yl-propan-1-ol.

### EXAMPLE 3

### (Preparation of heptanoic acid 1-thiophen-3-yl-propyl ester)

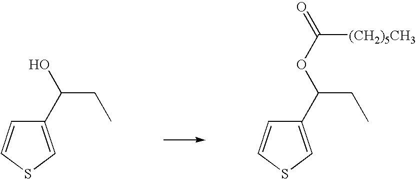

1 e.q. 1-thiophen-3-yl-propan-1-ol, 1.01 e.q. pyridine, small dimethylaminopyridine (DMAP), and tetrahydrofuran (THF) were mixed in a flask and stirred for 10 min under ice bath. Next, 1 e.q. 2-butyloctanoyl chloride was slowly added to form a solution. After warming to room temperature, the solution was stirred overnight. Next, the solution was concentrated to remove the excess pyridine. The concentrated solution was extracted with ethyl acetate and water. After removing water with magnesium sulfate (MgSO₄) and removing ethyl acetate, the results were purified to form heptanoic acid 1-thiophen-3-yl-propyl ester.

### EXAMPLE 4

### (Preparation of heptanoic acid 1-(2,5-dibromo-thiophen-3-yl)-propyl ester)

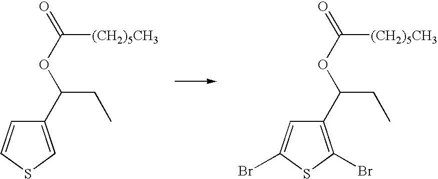

1 e.q. heptanoic acid 1-thiophen-3-yl-propyl ester, 2.5 e.q. N-bromosuccinimide (NBS), and dry tetrahydrofuran (THF) were mixed in a flask to form a solution. The flask was placed in a dry box. After taking the flask out of the dry box, the solution was stirred overnight at room temperature. The solution was then concentrated to remove tetrahydrofuran. Next, hexane was added. The solution was then filtered to remove most N-bromosuccinimide (NBS). After extracting air, the solution was placed back in the dry box and new 1.5 e.q. N-bromosuccinimide (NBS) and dry tetrahydrofuran were added thereto and stirred for 3 hours. Similarly, after concentration to remove tetrahydrofuran, hexane was added. The solution was then filtered to remove most N-bromosuccinimide (NBS). After extracting air, the results were purified to form heptanoic acid 1-(2,5-dibromo-thiophen-3-yl)-propyl ester.

### EXAMPLE 5

### (Preparation of 2,5-bis-trimethylstannanyl-thiophene)

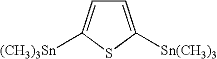

1.1 e.q. −78° C. 2,5-dibromothiophene and dry tetrahydrofuran (THF) were mixed in a first flask under nitrogen. Next, 2 e.q. n-butyl lithium (n-BuLi) was slowly added and stirred for 0.5 hour. 1 e.q. trimethyl tinchloride was then slowly added and stirred for 3 hours at −78° C. to form a solution. After removing tetrahydrofuran, the solution was extracted with ethyl acetate and water. After removing water with magnesium sulfate (MgSO₄) and removing ethyl acetate, the results were re-crystallized by acetonitrile and washed with acetonitrile to form 2,5-bis-trimethylstannanyl-thiophene.

### EXAMPLE 6

### (Preparation of polythiophene Derivative with ester Side Chain Group)

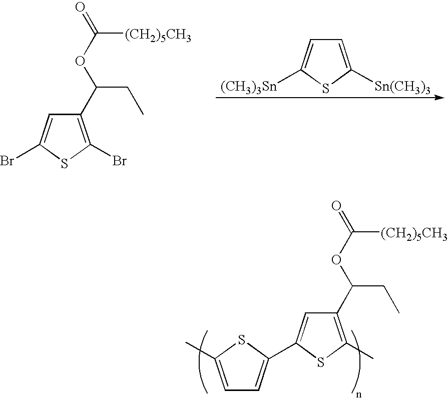

1 e.q. heptanoic acid 1-(2,5-dibromo-thiophen-3-yl)-propyl ester, 1 e.q. 2,5-bis-trimethylstannanyl-thiophene, 0.02 e.q. tetrakis(triphenylphosphine) palladium (Pd(PPh₃)₄), and dry chlorobenzene were added in a high-pressure bottle to form a solution. The high-pressure bottle was placed in a dry box. After taking the pressure bottle out of the dry box, the solution was freeze-pump-thawed five times to remove oxygen. After supplying nitrogen, the solution was stirred for 3 days at 130° C. under oil bath. Next, methanol was added to form a precipitate. The precipitate was then washed with a great quantity of methanol to form a polythiophene derivative containing an ester side chain group. The weight-averaged molecular weigh (Mw) of the polythiophene derivative is 15,500 g/mol.

### EXAMPLE 7

### (Preparation of Conjugated polythiophene Derivative with alkene Side Chain Group)

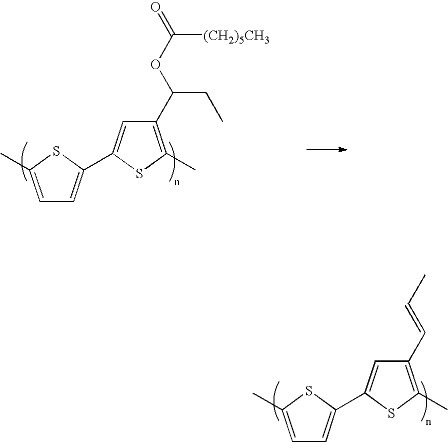

The polythiophene derivative of Example 6 was dissolved in xylene to form a solution. The solution was then spin-coated to form a film. Next, the film was heated to 150˜300° C. under vacuum or nitrogen to form a conjugated polythiophene derivative.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A polythiophene derivative having formula (I): 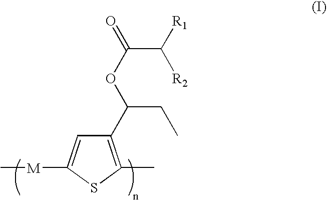
wherein M comprises 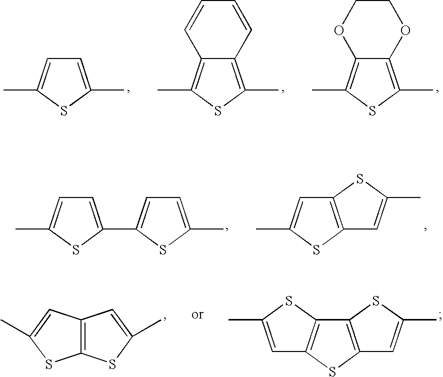
R₁ comprises C1˜C20 alkyl or C1˜C20 alkoxyalkyl;
R₂ comprises hydrogen, C1˜C20 alkyl, or C1˜C20 alkoxyalkyl; and
n is 1˜400.

2. The polythiophene derivative as claimed in claim 1, wherein the polythiophene derivative is dissolved in organic solvent.

3. The polythiophene derivative as claimed in claim 1, wherein the polythiophene derivative is applied in organic semiconductor devices.

4. The polythiophene derivative as claimed in claim 3, wherein the polythiophene derivative is applied in organic thin film transistors, organic solar cells, or organic light emitting diodes.

5. The polythiophene derivative having formula (II): 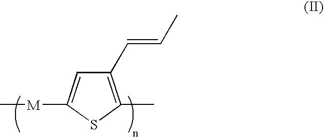
wherein M comprises 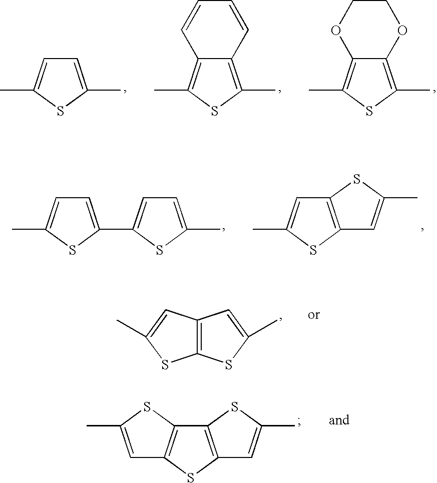
n is 1˜400.

6. The polythiophene derivative as claimed in claim 5, wherein the polythiophene derivative is undissolved in organic solvent.

7. The polythiophene derivative as claimed in claim 5, wherein the polythiophene derivative is applied in organic semiconductor devices.

8. The polythiophene derivative as claimed in claim 7, wherein the polythiophene derivative is applied in organic thin film transistors, organic solar cells, or organic light emitting diodes.
